(19) United States
(12) Patent Application Publication
(10) Pub. No.: US 2023/0211348 A1
(43) Pub. Date: Jul. 6, 2023

(54) DEVICE FOR HOLDING TUBES USED FOR ANALYSING SAMPLES BY MEANS OF NUCLEIC ACID AMPLIFICATION TECHNIQUES AND METHOD FOR USING SUCH A DEVICE

(71) Applicant: BIOMÉRIEUX, Marcy l'Etoile (FR)

(72) Inventors: Michel GUY, Grenoble (FR); Nicolas DELEPAUT, Grenoble (FR)

(73) Assignee: BIOMÉRIEUX, Marcy l'Etoile (FR)

(21) Appl. No.: 18/000,866

(22) PCT Filed: Jun. 11, 2021
(86) PCT No.: PCT/FR2021/051049

§ 371 Date: Dec. 6, 2022

(30) Foreign Application Priority Data
Jun. 12, 2020 (FR) FR2006165

(51) Int. Cl. B01L 9/06

(52) U.S. Cl. CPC B01L 9/06; B01L 2300/042; B01L 2200/16; B01L 2200/028; B01L 2300/044

(57) ABSTRACT

The invention relates to a device comprising:
a support tray (7) for tubes receiving samples to be analyzed, this tray (7) having holes (8) adapted to each receive a tube bearing on the upper surface and with its bottom protruding from the tray;
a lid (10) provided with chimneys (11) arranged according to a distribution similar to the distribution of the holes of the tray, this lid (10) being designed to occupy at least one position of superposition above the tray (7), so that the lid can be removably assembled to the tray to form a unitary assembly for holding the tubes and to position the chimneys (11) above the tubes in order to guide the pipette tips penetrating inside the tubes.

### TECHNICAL FIELD

The present invention relates to the technical field of devices used to handle tubes receiving biological samples to be analyzed.

The device in accordance with the invention generally relates to the process of samples for analysis, in the field of microbiology. It finds particularly advantageous applications to help in the handling of the tubes receiving biological samples to be analyzed by nucleic acid amplification techniques such as the Polymerase Chain Reaction (or PCR) and similar methods.

### PRIOR ART

The nucleic acid amplification techniques are well-known techniques in the prior art. These techniques and in particular the PCR implement different steps to prepare and analyze biological samples, in particular steps of rehydration of reagents, mixing of reagents with the sample, centrifugation, amplification and detection. This technique uses tubes pre-filled with reagents and each closed with a sealing plug. These tubes are intended to receive the biological samples to be analyzed. These tubes are handled by suitable devices in order to carry out the different steps of this technique.

In the prior art, there are many devices to ensure the implementation of the PCR technique while allowing the simple and safe handling of the tubes when carrying out the different steps of this technique.

For example, document CN 107868752 describes a device including a support plate for sample tubes to be analyzed, intended to be supported by a stand provided with a positioning base in an analysis machine. This device also includes a lid provided with legs intended to be magnetically fixed to the stand, so that the tube support plate is immobilized between the stand and the lid. Moreover, this lid is provided with passage holes for a pipette tip that are matching the tubes. Such a device allows simultaneously handling a set of tubes for its loading and its positioning in the analysis machine.

However, such a device does not guarantee the immobilization of the tubes on the stand. Indeed, the system for assembling the lid to the stand by a magnetic force does not allow developping a sufficient assembly force when the tubes supported by such a device undergo in particular the centrifugation operation. Moreover, the presence of the lid above the tubes makes the operation of deposition inside the tubes even more complex, operation which is delicate to conduct since the pipette must ensure the deposition of a drop of small volume, typically from 5 to 10 microliters, inside the tubes.

U.S. Pat. No. 7,329,393 describes a device for supporting sample tubes to be analyzed, adapted to undergo a centrifugation operation. Such a device includes a lid intended to be fixed to a base by a screw assembly system and between which a tube receiving tray and a support block are interposed. If such a device allows an effective holding of the tubes when they undergo the centrifugation operation, the mounting and dismounting operations prove to be relatively long to conduct. It follows that the use of such a device is limited in practice to this centrifugation operation. Moreover, such a device does not provide a solution to the problem of deposition of the samples inside the tubes.

The patent application US 2015/0132841 describes an assembly including a support for containers receiving samples to be analyzed and a lid provided with openings arranged according to a distribution similar to the containers. The lid is temporarily assembled to the support using fixing elements such as elastically deformable arms extending from the support and cooperating with protrusions carried by the lid. Such an assembly allows holding the containers in position. However, such an assembly does not provide a solution to the problem of deposition of the samples inside the containers.

### DISCLOSURE OF THE INVENTION

One object of the invention is to overcome the drawbacks of the prior art by proposing a support device for tubes intended to receive reagents necessary for an amplification reaction and biological samples to be analyzed, such a device being able to be implemented in a simple and effective manner for different prior operations or during an amplification reaction.

One object of the invention is to propose a support device for tubes receiving reagents necessary for an amplification reaction and biological samples to be analyzed, designed to immobilize the tubes in a simple and safe manner even during a centrifugation operation while allowing a securing of the operation of deposition inside the tubes.

To achieve such objectives, the object of the invention aims to propose a device comprising:
a support tray for tubes receiving samples to be analyzed and into which the tip of a pipette is intended to be introduced, this tray including a plate having an upper face and a lower face and holes arranged according to a determined distribution by opening out into these two faces and adapted to each receive a tube bearing on the upper surface and with its bottom protruding from the lower face of the tray, the plate of the tray being delimited by two longitudinal flanged edges parallel to each other and connected to each other by two transverse flanged edges parallel to each other;
a lid including a plate having an upper face and a lower face, provided with chimneys arranged according to a distribution similar to the distribution of the holes of the tray and provided with abutments for limiting the depression for pipette tips, the plate of the lid being delimited by two longitudinal flanged edges parallel to each other and connected to each other by two transverse flanged edges parallel to each other;
the tray and the lid including a removable assembly system including two elastically deformable legs arranged in the flanged edges of the lid and each cooperating with a complementary housing arranged in each of the flanged edges of the tray to achieve an elastic interlocking, when the lid occupies a position of superposition above the tray and bearing through its flanged edges on the tray to form a unitary assembly for holding the tubes and to position the chimneys above the tubes in order to guide the pipette tips penetrating inside the tubes and to stop them by the abutments so that the distal end of the pipette tip substantially reaches the inner wall of the bottom of the tubes.

According to one advantageous characteristic, the lid is designed to occupy a position of superposition below the tray to place the chimneys so that they ensure the holding of the bottom of the tubes protruding from the lower face of the tray.

In addition, the device according to the invention can further include in combination at least either or both of the following additional characteristics:
the tray and the lid are made of translucent or transparent materials;
the flanged edges of the lid delimit a border whose rim is bearing on the lid when the lid occupies a position of superposition above the tray;
the flanged edges of the lid and the flanged edges of the tray include nesting parts intended to be nested together so that when the lid is assembled with the tray while being above the tray, the footprint of the lid delimited by its flanged edges is equal to the footprint of the tray delimited by its flanged edges;
the nesting parts of the lid and of the tray are arranged with a foolproof system to ensure a direction of mounting of the lid on the tray;
the lid includes, from its upper face, a centering system for the tray bearing through its flanged edges on the lid, the height of the flanged edges of the tray being adapted to ensure the engagement of the chimneys on part of the height of the tubes from their bottom;
the centering system is set back from the flanged edges of the lid to receive the flanged edges of the tray so that the footprint of the lid delimited by its flanged edges is equal to the footprint of the tray delimited by its flanged edges;
the chimneys of the lid include abutments for limiting the depression of the pipette tips so that the tips substantially reach the inner wall of the bottom of the tubes;
the chimneys each protrude from the plate of the lid;
the chimneys each delimit an opening having, from the upper face of the lid, a frustoconical-shaped section opening from its largest section, on the upper face of the lid to guide the pipette tip;
the tray includes bearing ribs protruding from the upper face of the tray to serve as a bearing for a bearing element of an analysis machine.

Another object of the invention is to propose a method for using a device in accordance with the invention as part of a process performing a nucleic acid amplification.

The object of the invention aims to propose a method for using a device in accordance with the invention, as part of a process performing a nucleic acid amplification, implementing tubes intended to receive biological samples to be analyzed, the method consisting of:
inserting into the holes of a tray, tubes pre-filled with a lyophilized or liquid reagent and each closed by a plug provided with a slot allowing by elastic deformation, the passage of a pipette tip, the plug bearing on the upper surface of the tray;
placing a lid in a position of superposition above and bearing on the tray and removably assembling it to the tray to form a unitary assembly for holding the tubes and with chimneys positioned above the tubes.

According to one preferred exemplary implementation, the method consists of:
introducing the tip of a pipette for injecting a liquid through the chimneys of the lid that guide the tip to penetrate through the plugs and inside the tubes up to an abutment carried by the chimneys of the lid so that the tip substantially reaches the inner wall of the bottom of the tubes;
delivering the sample into the tubes using the pipette;
and removing the tip of the pipette from the tubes, the plugs and the chimneys.

According to one variant, a film able to be perforated by a tip of a pipette is interposed between the plugs and the lid, before the assembly between the tray and the lid, so as to serve as a fill indicator for filling the tubes with the aqueous solution.

According to another variant, a film able to be perforated by a tip of a pipette is placed on the upper surface of the chimneys of the lid.

According to one step of the method, the unitary assembly for holding the tubes between the lid and the tray is introduced into a centrifugation machine, in particular a vertical machine, to ensure an operation of centrifugation of the contents of the tubes.

According to the invention, after carrying out the centrifugation operation:
the lid is separated from the tray and deposited on a laying plane;
the tray is placed in a position of superposition above the lid so as to engage the bottom of the tubes protruding from the lower face of the tray in the chimneys of the lid so that they ensure the holding of the tubes;
the plugs of the tubes are removed to be replaced by optical plugs to allow carrying out an operation of amplification of the nucleic acids contained in the tubes;
the lid is placed in a position of superposition above the tray and removably assembled to the tray in order to form a unitary assembly for holding the tubes.

According to another step, the method consists of:
loading the unitary assembly for holding the tubes in an analysis machine;
removing the lid relative to the tube support tray;
holding the tubes against the tray, by a bearing element of the analysis machine, during a tube heating operation;
and carrying out the operation of amplification of the contents of the tubes by the analysis machine.

### BRIEF DESCRIPTION OF THE DRAWINGS

FIG. 1 is a perspective of the device in accordance with the invention illustrated in a first configuration in which the tube support tray is located below a lid.

FIG. 2 is a perspective view showing the lower face of the tube support tray of the device in accordance with the invention.

FIG. 3 is a perspective view showing the lower face of the lid of the device in accordance with the invention.

FIG. 4 is a perspective of the device in accordance with the invention illustrated in a first assembled superposition position in which the lid is located above the tube support tray.

FIG. 5 is an elevation sectional view taken substantially along the line V of FIG. 4 and showing a detail of the unitary assembly composed of the assembly of the lid and the tube support tray.

FIG. 6 is a plan view of the device in accordance with the invention illustrated in FIG. 4 in the second assembled superposition position and whose three pipette tips are introduced into tubes.

FIG. 7 is a sectional view of the device in accordance with the invention in the second assembled superposition position, taken substantially along the lines VII-VII of FIG. 6.

FIG. 8 is a perspective view of the device in accordance with the invention illustrated in a second configuration in which the lid is located below the tube support tray.

FIG. 9 is a perspective view of the device in accordance with the invention illustrated in a second assembled superposition position in which the tube support tray is located above the lid.

FIG. 10 is a partly sectional perspective view of the device in accordance with the invention illustrated in the second assembled superposition position in which the tube support tray is located above the lid.

### DESCRIPTION OF THE EMBODIMENTS

As appearing from the drawings, the object of the invention relates to a device 1 intended to be used advantageously as part of a nucleic acid amplification process such as a Polymerase Chain Reaction or the like, implementing tubes 2 intended to receive biological samples to be analyzed and reagents necessary for an amplification reaction. Each tube 2 is pre-filled with a lyophilized reagent or a liquid reagent. By reagent, it is meant any substance or mixture of substances necessary for the implementation of an amplification reaction. Conventionally, the reagents are enzymes, nucleotides, primers, probes and other components necessary for the amplification. In the case of the PCR, a PCR mix which contains the components necessary for the PCR such as enzymes, nucleotides, ions, a buffer, is used.

By sample, it is meant a small part or small amount separated from an entity by a subtractive act usually called collection, for the purpose of analysis. The sample can be of human, animal, plant or environmental origin. It can correspond to a biological fluid collection (whole blood, serum, plasma, urine, cerebrospinal fluid, organic secretion), a tissue collection or isolated cells. It can be of industrial origin, i.e., according to a non-exhaustive list, an air collection, a water collection, a collection taken from a surface, a part or a product being treated or manufactured, a product of food origin. This sample may possibly have undergone a prior treatment, involving for example lysis, mixing, dilution or grinding steps, particularly if the originating entity is in the solid state. The sample deposited in the tubes can therefore be in liquid form. The biological sample analyzed is, in general, likely to contain or suspected of containing at least one target microorganism.

Each tube 2 has a tubular body 2t whose lower part is closed so as to present a bottom 2f from this closed lower end. Each tube 2 has an upper part 2s adapted to be equipped with a plug 3 for sealing the tube. This plug 3 is provided with a slot 4 adapted to allow, by elastic deformation, the passage of a tip 5 of a pipette for injecting a liquid solution inside the tube 2.

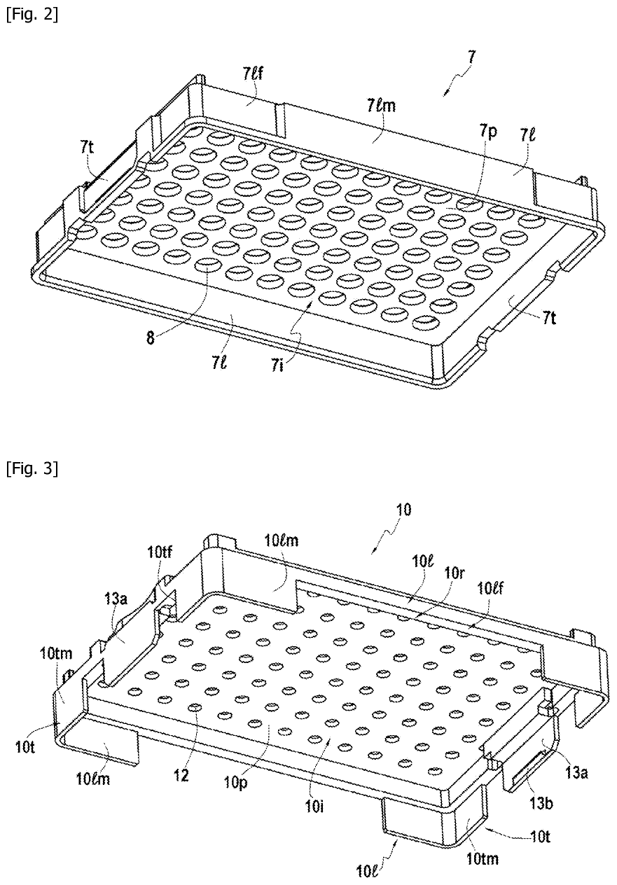

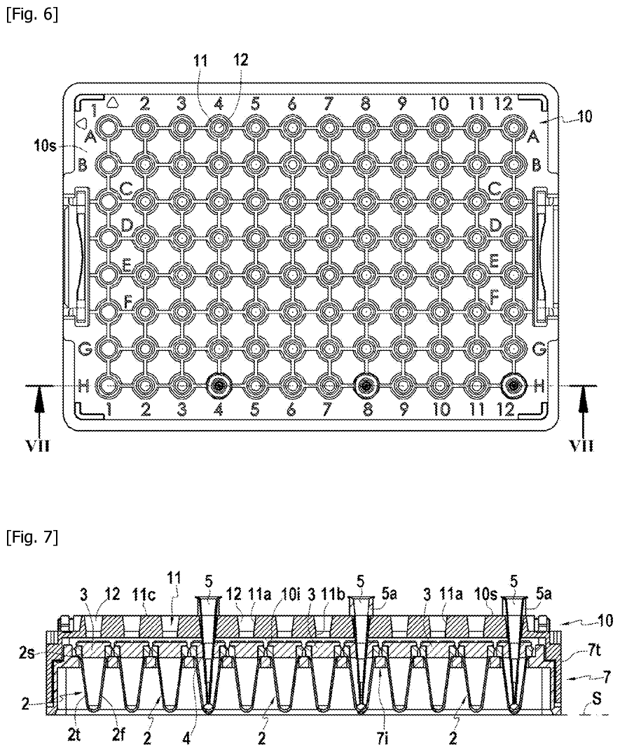

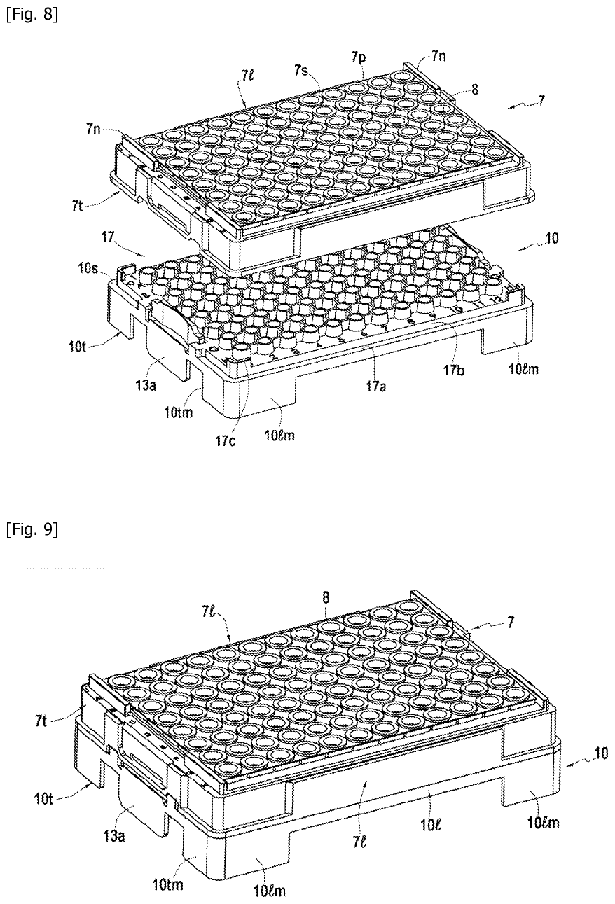

In accordance with the invention, the device 1 comprises a support tray 7 for the tubes 2 having an upper face 7s and a lower face 7i (FIGS. 2 and 8). This tray 7 includes holes 8 arranged to open out into the upper face 7s and the lower face 7i. Each hole 8 is adapted to receive, as illustrated in FIGS. 6, 7 and 10, a tube 2 inserted inside the hole 8 and bearing on the upper surface 7s of the tray while the bottom 2f of the tube protrudes from the lower face 7i of the tray 7 (FIG. 7).

The holes 8 are arranged in the tray 7 according to a determined distribution. Preferably, the holes 8 are arranged in rows and columns. Typically, the tray 7 includes eight rows of holes 8 referenced from A to H and twelve columns of holes 8 referenced from 1 to 12, that is to say 96 holes.

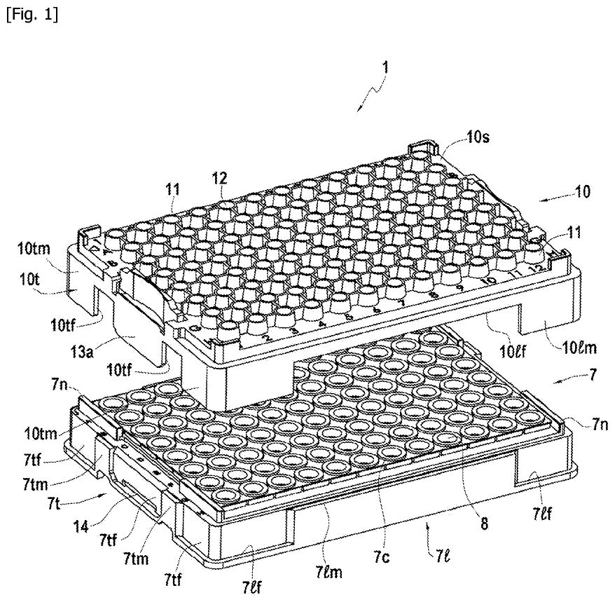

In accordance with the invention, the device 1 also comprises a lid 10 having an upper face 10s and a lower face 10i, and provided with chimneys 11 internally delimiting openings 12 each opening out onto the upper surface 10s and the lower surface 10i of the lid (FIGS. 1 and 3). These chimneys 11 or openings 12 are arranged according to a distribution similar to the distribution of the holes 8 of the tray 7 so that in the position of superposition of the tray 7 and the lid 10, the holes 8 of the tray 7 coincide or are aligned with the openings 12 of the chimneys 11. In the example illustrated, the lid 10 includes eight rows of chimneys 11 referenced from A to H and twelve columns of chimneys 11 referenced from 1 to 12, that is to say 96 chimneys 11 or openings 12.

In accordance with the invention, the lid 10 and the tray 7 are adapted to cooperate together in a first stacking or superposition position and also, advantageously in a second stacking or superposition position each adapted for the implementation of specific steps in the process of analyzing the biological samples contained in the tubes. The lid 10 is designed to occupy at least one position of superposition above the tray 7 so as to be removably assembled to the tray to form a unitary assembly for holding the tubes by the lower face of the lid and to position the chimneys 11 above the tubes to guide the pipette tips (FIGS. 1, 4, 5, 6, 7). According to one advantageous characteristic of embodiment, the lid 10 is designed to occupy a second position corresponding to a position of superposition of the lid 10 below the tray 7, in which the chimneys 11 are placed so as to ensure the holding of the bottom of the tubes protruding from the lower face 7i of the tray 7 (FIGS. 8, 9, 10).

According to one preferred variant, the tray 7 and the lid 10 have a rectangular shape. The tray 7 includes a plate 7p delimited by two longitudinal flanged edges 7l parallel to each other and connected to each other by two transverse flanged edges 7t parallel to each other (FIG. 2). The plate 7p of the tray is thus provided along its entire periphery with the flanged edges 7l, 7t forming a continuous border protruding from the lower face 7i of the tray. The tray 7 is intended to bear on a laying plane S by the rim of this continuous border so that advantageously, the height of the flanged edges 7t, 7l forming this border is substantially higher than the length of the tubes 2 protruding from the lower face 7i of the tray when the tubes 2 are supported by the tray (FIG. 7).

It should be noted that the lower face 7i of the tray 7 has a planar surface while the upper face 7s of the tray is provided with flanges 7c each surrounding a hole 8 and allowing the positioning of the tubes 2 (FIG. 1). According to one advantageous characteristic of embodiment, the tray 7 includes bearing ribs 7n protruding from the upper face 7s of the tray to ensure homogeneous bearing for a bearing element of an analysis machine. As will be explained in detail in the remainder of the description, these bearing ribs 7n serve as angular compensation when the distribution of the tubes 2 is heterogeneous on the tray 7. As illustrated in FIG. 8, the bearing ribs 7n protrude from the upper face 7s of the tray in the vicinity of and parallel to the two transverse flanged edges 7t of the tray.

Similarly, the lid 10 includes a plate 10p delimited by two longitudinal flanged edges 10l parallel to each other and connected to each other by two transverse flanged edges 10t parallel to each other (FIGS. 1 and 3). The plate 10p of the lid 10 is thus provided along its entire periphery with the flanged edges 10l, 10t forming a border protruding from the lower face 10i of the lid. This border delimited by the flanged edges 10l, 10t has a rim 10r intended to bear on the upper face 7s of the tray 7 when the lid 10 occupies the position of superposition above the tray 7. Thus, the lid 10 is bearing on the tray 7 through its flanged edges 10l, 10t. It should be noted that the lower face 10i of the lid has a planar surface while the upper face 10s of the lid is provided with the chimneys 11. In the example illustrated, the chimneys 11 protrude from the plate 10p of the lid. Of course, it can be provided that the chimneys 11 are completely made by the plate 10p of the lid so that the upper face 10s of the plate 10p would have a planar surface. In this embodiment, the plate 10p of the lid has a constant thickness and each chimney 11 is formed by the wall delimiting the opening 12 and whose height corresponds to the thickness of the plate 10p of the lid 10.

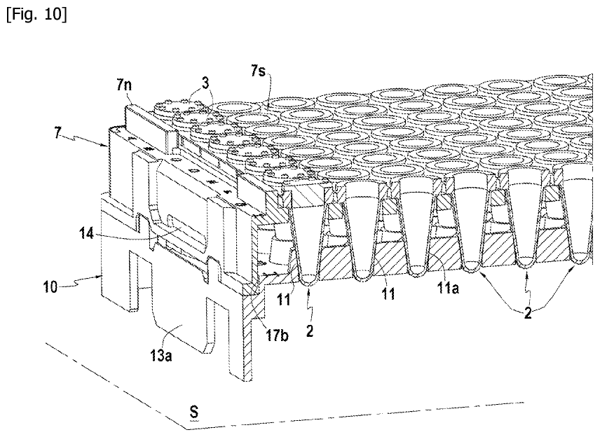

It must be considered that each chimney 11 delimits by its inner wall, a guide surface for the tip of a pipette during the operation of deposition of a liquid inside the tube. Each opening 12 of a chimney 11 thus has a section and a shape adapted to ensure this guiding function. As seen in FIG. 7, each opening 12 of a chimney 11 has, from the upper face 10s of the lid, a frustoconical—shaped section 11a opening from its largest section, on the upper face 10s of the lid. For example, this frustoconical section 11a is extended by a tubular section 11b opening on the lower face 10i of the lid 10. According to one advantageous characteristic, the frustoconical section 11a of the chimneys is adapted to also ensure the engagement of the bottom of the tubes 2 which generally also has a frustoconical section (FIG. 10).

The chimneys 11 of the lid 10 include abutments 11c for limiting the depression of the tips 5 of the pipettes so that the tips substantially reach the inner wall of the bottom of the tubes (FIG. 7). In other words, the abutments 11c are arranged on the lid 10 so that, in the bearing position of the lid 10 on the tray 7, the distal end of the tip 5 of the pipette arrives, at the end of engagement travel, in the vicinity of the wall of the bottom of the tube as seen in FIG. 7. The position of the abutments 11c relative to the bearing rim 10r is such that in the position of superposition of the lid 10 above the tray 7, the distal end of the tip 5 of the pipette is located in the vicinity of the wall of the bottom of the tube. For example, the abutments 11c are formed by the upper rim of the chimneys 11 on which fins 5a of the tips 5 of the pipettes come into contact. In this abutment or stop position, the distal end of the tip 5 of the pipette is in the vicinity of the wall of the bottom of the tube, when the lid 10 occupies its first superposition position bearing on the tray 7. The positioning of the distal end of the tip 5 of the pipette in the vicinity of the wall of the bottom of the tube thus allows securing the operation of deposition of the liquid inside the tube 2. Indeed, during a deposition of a small volume, it is necessary to make the drop touch the inner wall of the tube in order to prevent it from remaining attached to the tip of the pipette. Its transfer is thus carried out with certainty according to the good practices in the use of a pipette.

According to one preferred variant, the tray 7 and the lid 10 are made of translucent or transparent materials. Typically, the tray 7 and the lid 10 are generally made of polycarbonate, but could also be made of polypropylene, high—density polyethylene.

According to one characteristic of the invention, the tray 7 and the lid 10 include a removable assembly system 13 allowing the lid 10 and the tray 7 to be fastened together to form a unitary assembly for holding the tubes 2. In this assembled position, the lid 10 occupies a position of superposition above the tray 7, with the lid 10 bearing on the tray 7 and with the plate 10p of the lid located above the plate 7p of the tray. The removable assembly system 10 is also adapted so that the lid 10 and the tray 7 can be easily separated so that they can be handled independently and positioned for example to occupy another stacked position. The removable assembly system 13 can be made in any suitable manner. In the preferred exemplary embodiment illustrated in the drawings, the removable assembly system 13 is of the elastic interlocking type.

According to the exemplary embodiment illustrated in the drawings, the tray 7 and the lid 10 include, as a removable assembly system 13, two legs 13a arranged in the preferably transverse flanged edges 10t of the lid 10 and each cooperating with a complementary housing 14 arranged in each of the transverse flanged edges 7t of the tray 7 to achieve an elastic interlocking. As seen in FIGS. 1, 3, 4 and 5, each transverse flanged edge 10t of the lid 10 includes two cutouts 10tf delimiting therebetween an elastically deformable leg 13a. Each leg 13a is provided at its free end, on its inner surface, with a rib 13b intended to engage in the complementary housing 14 which delimits an abutment surface 14a for the rib 13b (FIG. 5). When the legs 13a of the lid 10 are blocked by the abutment surfaces 14a of the tray 7, the lower face of the plate 10p of the lid is positioned above and in the vicinity of or in contact with the plugs of the tubes 2 supported by the tray 7. In this position, the tubes 2 are immobilized, between the tray 7 and the lid 10.

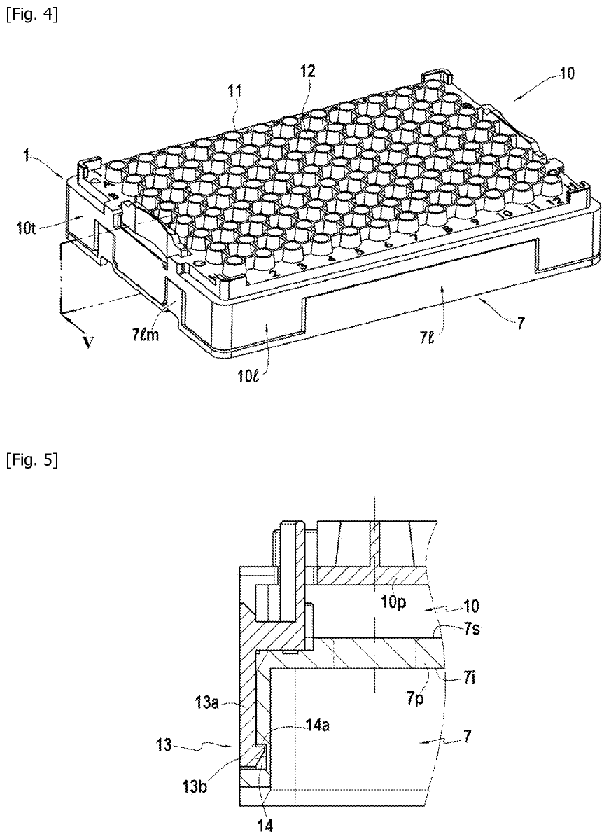

According to one advantageous characteristic of embodiment, the flanged edges 10t, 10l of the lid 10 and the flanged edges 7t, 7l of the tray 7 include nesting parts respectively 10tm, 10tf, 10lm, 10lf and 7tm, 7tf, 7lm, 7lf intended to be nested together so that, when the lid 10 is assembled with the tray 7 while being above the tray 7, the footprint of the lid 10 delimited by its flanged edges 10t, 10l is equal to the footprint of the tray 7 delimited by its flanged edges 7t, 7l. In this position illustrated in FIG. 4, the unitary assembly composed of the lid 10 and the tray 7 is a solid parallelepipedic with planar side surfaces formed by the flanged edges 10t, 10l of the lid aligned with the flanged edges 7t, 7l of the tray.

The nesting between the flanged edges 10t, 10l of the lid 10 and the flanged edges 7t, 7l of the tray 7 can be obtained using the nesting parts 10tm, 10tf, 10lm, 10lf and 7tm, 7tf, 7lm, 7lf made in any suitable manner. In the exemplary embodiment illustrated in the Figures, each longitudinal flanged edge 7l of the tray 7 includes two nesting parts 7lf called female nesting parts formed by housings arranged in the longitudinal flanged edges 7l and made on either side of a nesting part called male nesting part 7lm. Each longitudinal flanged edge 10l of the lid 10 includes two nesting parts 10lm called male nesting parts delimited on either side by a nesting part called female nesting part 10lf made by a cutout. The two male nesting parts 10lm and the female nesting part 10lf of each longitudinal flanged edge 10l of the lid 10 are intended to be nested respectively into the two female nesting parts 7lf and in the male nesting part 7lm of each transverse edge 7t of the tray 7. Of course, the female nesting parts 10lf and the male nesting parts 10lm of the lid have shapes respectively congruent or complementary to the male nesting parts 7lm and to the female nesting parts 7lf of the tray 7.

Similarly, each transverse flanged edge 10t of the lid 10 includes two nesting parts called female nesting parts 10tf formed by the cutouts made on either side of a male nesting part made by the leg 13a, these cutouts 15 leaving to each corner a male nesting part 10tm. The two female nesting parts 10tf and the three male nesting parts 13a, 10tm of each transverse flanged edge 10t of the lid are intended to be nested respectively into two male nesting parts 7tm and in three female nesting parts 7tf of each transverse flanged edge 7t of the tray 7. The three female nesting parts 7tf of each transverse flanged edge 7t of the tray 7 are for example housings arranged in these transverse flanged edges 7t of the tray 7. Of course, the female nesting parts 10tf and the male nesting parts 13a, 10tm of the lid 10 have shapes respectively congruent or complementary to the male nesting parts 7tm and to the female nesting parts 7tf of the tray 7. It should be noted that the male nesting parts 10lm of the longitudinal flanged edges and the male nesting parts 13a, 10tm of the transverse flanged edges 10t of the lid 10 protrude from the rim 10r of the flanged edges and over only part of the width of this border so that the rim 10r remains in line with the male nesting parts (FIG. 3). The lid 10 thus has from its flanged edges, a rim 10r extending substantially continuously over the entire periphery of the plate 10p making it possible to obtain a stable bearing of the lid 10 on the tray 7.

According to one advantageous characteristic of embodiment, the nesting parts of the lid 10 and the tray 7 are arranged with a foolproof system to ensure a direction of mounting of the lid on the tray. According to the exemplary embodiment illustrated in the Figures, the two female nesting parts 7lf of a longitudinal flanged edge of the tray 7 and consequently the corresponding two male nesting parts 10lm of the lid are arranged asymmetrically. As is apparent for example from FIG. 1, the length taken along a longitudinal edge of a female nesting part 7lf of the tray (respectively of a male nesting part 10lm) is different from the length of the other female nesting part 7lf of the tray (respectively of the other male nesting part 10lm). Such an asymmetrical construction of the nesting parts allows the mounting of the lid 10 on the support 7 along only one direction.

As indicated above, the lid 10 is designed to occupy a second stacking position corresponding to a position of superposition of the lid 10 below the tray 7 (FIGS. 8, 9 and 10). In this second superposition position, the tray 7 is bearing on the upper face 10s of the lid 10, through the rim of its flanged edges 7t, 7l. According to one preferred characteristic of embodiment, the lid 10 includes, from its upper face 10s, a centering system 17 for the tray 7 so that the lid 10 and the tray 7 are fastened together at least in a horizontal plane.

According to one preferred variant, the centering system 17 is arranged so that the footprint of the lid 10 delimited by its flanged edges 10t, 10l is equal to the footprint of the tray 7 delimited by its flanged edges 7t, 7l. In other words, the longitudinal 10l and transverse 10t flanged edges of the lid 10 are located in alignment with or in the extension of respectively the longitudinal 7l and transverse 7t flanged edges of the tray. As seen more specifically in FIG. 8, the centering system 17 is set back from the flanged edges of the lid 10 to receive the flanged edges of the tray 7 so that the flanged edges 10t, 10l of the lid 10 are aligned with the flanged edges 7t, 7l of the tray 7.

In the example illustrated, the centering system 17 includes a groove 17a arranged from the upper face 10s of the lid 10, by opening at the periphery of the plate 10p of the lid to allow the engagement of the longitudinal 7l and transverse 7t flanged edges of the tray. This groove 17a thus delimits a centering rim 17b for the longitudinal 7l and transverse 7t flanged edges of the tray. For example, this centering rim 17b can be extended punctually, at each corner of the lid 10, by centering studs 17c protruding from the upper face of the lid 10. It should be noted that it can be provided that the centering rim 17b of the lid 10 has a section adapted to achieve, with the section delimited by the inner surface of the flanged edges of the tray 7, a tight fit leading to a complete fastening of the tray 7 with the lid 10. The tray 7 and the lid 10 thus form a unitary assembly in this second stacking position.

In this second stacking position, the height of the flanged edges 7t, 7l of the tray 7 is adapted to ensure the engagement of the chimneys 11 of the lid over part of the height of the tubes 2 from their bottom (FIG. 10). The engagement of the tubes 2 through their bottom inside the openings 12 of the chimneys 11 ensures a centering of the tubes avoiding their tilting in particular during the execution of different interventions on the tubes and/or the plugs, as will be explained in detail in the remainder of the description.

It appears from the foregoing description that the device 1 in accordance with the invention includes two separate elements which can be fastened together in two different stacking positions to allow the handling of the tubes in order to ensure the accomplishment of various steps of treating the biological samples contained in these tubes. It should be noted that such devices 1 can be piled or stacked on top of each other in either of the superposition position.

The device 1 in accordance with the invention is particularly suitable for use as part of a process performing a nucleic acid amplification such as the Polymerase Chain Reaction or the like, implementing tubes 2 intended to receive biological samples to be analyzed. Each tube 2 can be pre-filled with a lyophilized or liquid reagent. It should be noted that the contents of each tube 2 may also have undergone one or several treatment step(s), such as a lyophilization operation. Each tube 2 thus pre-filled is sealed using a plug 3 provided with a slot 4 authorizing by elastic deformation the passage of a tip 5 of a pipette.

The method of implementing the device 1 consists of:
inserting into the holes 8 of the tray 7, the tubes 2 pre-filled with a reagent and each closed by a plug 3 provided with a slot and bearing on the upper surface 7s of the tray 7;
placing the lid 10 in a position of superposition above the tray 7 (FIG. 1) and removably assembling the lid 10 to the tray 7 in order to form a unitary assembly (FIG. 4).

The assembly of the lid 10 to the tray 7 is carried out in a simple manner by the approximation of the lid 10 relative to the tray 7. During this approximation, the elastic legs 13a are elastically deformed outwardly until the ribs 13b of the elastic legs 13a penetrate into the housings 14 to be blocked by the abutment surfaces 14a of the tray 7. It should be noted that during this assembly operation, the lid 10 is slidably guided on the tray 7 by the cooperation of the nesting parts of the lid 10 with the nesting parts of the tray 7.

In this assembly position, the lower face 10i of the plate 10p of the lid 10 is positioned above the plugs of the tubes 2 supported by the tray 7 to hold them in position. The lid 10 is bearing on the tray 7, through the rim 10r of its flanged edges 10l, 10t. In this position, the tubes 2 are immobilized or blocked, between the tray 7 and the lid 10 and the chimneys 11 of the lid 10 are positioned above the tubes 2 (FIG. 7).

The next step in the preparation of a sample for a Polymerase Chain Reaction or the like consists of introducing the tip 5 of a pipette for injecting a liquid through the chimneys 11 of the lid and the slots 4 of the plugs 3 so as to open out inside the tubes 2 (FIGS. 6 and 7). It should first of all be noted that the chimneys 11 guide the operator to correctly position the tip of the pipette to ensure its introduction inside the tubes 2. Indeed, the operator introduces into the opening 12 chimneys 11, the tip 5 which is guided throughout its travel, namely when approaching the plug 3 by the frustoconical—shaped portion 11a, during its penetration into the slot 4 of the plug which deforms elastically, and inside the tube 2.

Advantageously, the travel of the pipette is limited by the abutments 11c of the chimneys 11 so that the distal end of the tip of the pipette is in the vicinity of or in contact with the wall of the bottom of the tube. The tip of the pipette is ideally positioned in the vicinity of the wall of the tube so as to ensure the operation of deposition of the liquid inside the tube 2. This depositing operation which is an operation delicate to conduct since the liquid to be deposited is generally a drop of small volume typically from 5 to 10 microliters, is thus secured.

After having delivered the liquid in the tubes 2 using the pipette, the operator removes the tip from the pipette, the tubes 2, the plugs 3 and the chimneys 11. The liquid delivered is the sample. A reagent necessary for the amplification can also be added.

It should be noted that the transparency of the tray 7 and the lid 10 gives the operator the possibility of seeing the color code inside the tubes 2.

According to one variant, it should be noted that a film able to be perforated by a tip of a pipette is placed on the lid 10 so as to serve as a fill indicator for filling the tubes 2 with the liquid. This film, not represented in the drawings, can be placed on the upper surface of the chimneys 11 of the lid 10.

According to another variant, before the assembly between the tray 7 and the lid 10, a film able to be perforated by a pipette tip can be interposed between the plugs 3 and the lid 10, so to serve as a fill indicator for filling the tubes 2 with the liquid. This film, not represented in the drawings, can be deposited directly on the upper surface 7s of the tray provided with the plugs 3.

This unitary assembly with the tubes 2 immobilized between the lid 10 and the tray 7 can be introduced into a centrifugation machine of any type known per se to ensure an operation of centrifugation of the contents of the tubes 2. According to one advantage of the device 1 in accordance with the invention, the device 1 can be loaded in a vertical centrifugation machine without the risk of tube leaking. The compact nature of the device 1 facilitates the loading and unloading operations of the device 1.

After carrying out the centrifugation operation, the contents of the tubes 2 are intended to undergo a reaction of amplification of the nucleic acids contained in the tubes using an analysis machine of any type known per se, typically a thermal cycler. According to one variant of implementation, the plugs 3 sealing the tubes 2 are replaced by optical plugs before the operation of analyzing the contents of the tubes.

For this purpose, the lid 10 is separated from the tray 7 and deposited on a laying plane S. This operation is relatively easy to conduct since it suffices to spread the elastic legs 13a to disengage the ribs 13b from the housings 14 and to lift the lid 10 relative to tray 7 according to a translational movement. After bearing the lid 10 on a laying plane S, through its flanged edges 10l, 10t, the tray 7 is placed in a position of superposition above the lid 10 so as to engage the bottom of the tubes protruding from the lower face of the tray in the chimneys 11 of the cover so that they ensure the holding of the tubes. As seen more specifically in FIG. 10, each bottom of the tubes 2 is engaged in the opening 12 of the chimneys 11 avoiding any tilting movement during the operation of removing the plugs replaced by optical plugs for carrying out the operation of analyzing the contents of the tubes. It should be noted that the operation of analyzing the contents of the tubes can be conducted without changing the plugs 3 provided with a slot and initially sealing the tubes.

To perform the amplification of the nucleic acids contained in the tubes 2, the unitary assembly consisting of the tube 2 support tray 7 assembled with the lid 10 is loaded in the analysis machine. In the case where the plugs have been replaced by optical plugs, the tray 7 is disengaged from the lid 10 so that the lid can be placed above the tray 7 and fastened together using the removable assembly system 13 as already explained. This unitary assembly makes it easy and safe to load the set of tubes 2 in the analysis machine.

The lid 10 of the device 1 is removed from the tray 7 so as to allow the heating of the tubes 2 and the analysis operation. To this end, a bearing element of the analysis machine such as its lid holds the tubes 2 against the tray 7 while ensuring good contact of the tubes with the heating block of the analysis machine and in particular with the tube receiving wells arranged in the heating block. Advantageously, the lid of the analysis machine comes into contact with the bearing ribs 7n of the tray 7. The operation of amplification of the nucleic acids contained in the tubes 2 can therefore be conducted by the analysis machine.

It should be noted that during the amplification cycle, the tubes 2 are clamped in the heating block by the bearing element of the analysis machine. At the end of the cycle, it is possible to discharge from the analysis machine, the tubes 2 thanks to the tray 7. This thus allows simultaneously and easily removing the set of tubes 2 having undergone the reaction.

1. A device comprising:
a support tray (7) for tubes (2) receiving samples to be analyzed and into which the tip (5) of a pipette is intended to be introduced, this tray (7) including a plate (7p) having a upper face (7s) and a lower face (7i) and holes (8) arranged according to a determined distribution by opening out into these two faces and adapted to each receive a tube bearing on the upper surface and with its bottom protruding from the lower face of the tray, the plate (7p) of the tray being delimited by two longitudinal flanged edges (7l) parallel to each other and connected to each other by two transverse flanged edges (7t) parallel to each other;
a lid (10) including a plate (10p) having an upper face (10s) and a lower face (10i), provided with chimneys (11) arranged according to a distribution similar to the distribution of the holes of the tray and provided with abutments (11c) for limiting the depression for pipette tips (5), the plate (10p) of the lid being delimited by two longitudinal flanged edges (10l) parallel to each other and connected to each other by two transverse flanged edges (10t) parallel to each other;
the tray (7) and the lid (10) including a removable assembly system (13) including two elastically deformable legs (13a) arranged in the flanged edges of the lid and each cooperating with a complementary housing (14) arranged in each of the flanged edges of the tray to achieve an elastic interlocking, when the lid (10) occupies a position of superposition above the tray (7) and bearing through its flanged edges on the tray to form a unitary assembly for holding the tubes and to position the chimneys (11) above the tubes in order to guide the pipette tips penetrating inside the tubes and to stop them by the abutments (11c) so that the distal end of the pipette tip substantially reaches the inner wall of the bottom of the tubes.

2. The device according to claim 1, according to which the lid (10) is designed to occupy a position of superposition below the tray (7) to place the chimneys (11) so that they ensure the holding of the bottom of the tubes protruding from the lower face of the tray.

3. The device according to claim 1, according to which the tray (7) and the lid (10) are made of translucent or transparent materials.

4. The device according to claim 1, according to which the flanged edges (10l, 10t) of the lid (10) delimit a border whose rim (10r) is bearing on the lid (10) when the lid (10) occupies a position of superposition above the tray (7).

5. The device according to claim 1, according to which the flanged edges of the lid (10) and the flanged edges of the tray (7) include nesting parts (10tm, 10tf, 10lm, 10lf and 7tm, 7tf, 7lm, 7lf) intended to be nested together so that when the lid (10) is assembled with the tray (7) while being above the tray (7), the footprint of the lid (10) delimited by its flanged edges (10t, 10l) is equal to the footprint of the tray (7) delimited by its flanged edges (7l, 7t).

6. The device according to claim 5, according to which the nesting parts (10tm, 10tf, 10lm, 10lf and 7tm, 7tf, 7lm, 7lf) of the lid (10) and of the tray (7) are arranged with a foolproof system to ensure a direction of mounting of the lid (10) on the tray (7).

7. The device according to claim 1, according to which the lid (10) includes, from its upper face (10s), a centering system (17) for the tray (7) bearing through its flanged edges on the lid (10), the height of the flanged edges (7l, 7t) of the tray being adapted to ensure the engagement of the chimneys (11) on part of the height of the tubes from their bottom.

8. The device according to claim 7, according to which the centering system (17) is set back from the flanged edges (10l, 10t) of the lid (10) to receive the flanged edges of the tray so that the footprint of the lid delimited by its flanged edges is equal to the footprint of the tray delimited by its flanged edges.

9. The device according to claim 1, according to which the chimneys (11) of the lid (10) include abutments (11c) for limiting the depression of the pipette tips so that the tips substantially reach the inner wall of the bottom of the tubes.

10. The device according to claim 1, according to which the chimneys (11) each protrude from the plate (10p) of the lid (10).

11. The device according to claim 1, according to which the chimneys (11) each delimit an opening (12) having, from the upper face (10s) of the lid, a frustoconical-shaped section (11a) opening from its largest section, on the upper face (10s) of the lid to guide the pipette tip.

12. The device according to claim 1, according to which the tray (7) includes bearing ribs (7n) protruding from the upper face (7s) of the tray to serve as a bearing for a bearing element of an analysis machine.

13. A method for using a device as part of a process performing a nucleic acid amplification, implementing tubes (2) intended to receive biological samples to be analyzed, wherein the device comprises:
a support tray (7) for tubes (2) receiving samples to be analyzed and into which the tip (5) of a pipette is intended to be introduced, this tray (7) including a plate (7p) having a upper face (7s) and a lower face (7i) and holes (8) arranged according to a determined distribution by opening out into these two faces and adapted to each receive a tube bearing on the upper surface and with its bottom protruding from the lower face of the tray, the plate (7p) of the tray being delimited by two longitudinal flanged edges (7l) parallel to each other and connected to each other by two transverse flanged edges (7t) parallel to each other;
a lid (10) including a plate (10p) having an upper face (10s) and a lower face (10i), provided with chimneys (11) arranged according to a distribution similar to the distribution of the holes of the tray and provided with abutments (11c) for limiting the depression for pipette tips (5), the plate (10p) of the lid being delimited by two longitudinal flanged edges (10l) parallel to each other and connected to each other by two transverse flanged edges (10t) parallel to each other;
the tray (7) and the lid (10) including a removable assembly system (13) including two elastically deformable legs (13a) arranged in the flanged edges of the lid and each cooperating with a complementary housing (14) arranged in each of the flanged edges of the tray to achieve an elastic interlocking, when the lid (10) occupies a position of superposition above the tray (7) and bearing through its flanged edges on the tray to form a unitary assembly for holding the tubes and to position the chimneys (11) above the tubes in order to guide the pipette tips penetrating inside the tubes and to stop them by the abutments (11c) so that the distal end of the pipette tip substantially reaches the inner wall of the bottom of the tubes;
the method comprising:
inserting into the holes (8) of a tray (7), tubes pre-filled with a lyophilized or liquid reagent and each closed by a plug (3) provided with a slot (4) allowing by elastic deformation, the passage of a pipette tip (5), the plug bearing on the upper surface of the tray;
placing a lid (10) in a position of superposition above and bearing on the tray (7) and removably assembling it to the tray to form a unitary assembly for holding the tubes and with chimneys (11) positioned above the tubes.

14. The method according to claim 13, comprising:
introducing the tip (5) of a pipette for injecting a liquid through the chimneys (11) of the lid that guide the tip to penetrate through the plugs (3) and inside the tubes (2) up to an abutment (11c) carried by the chimneys (11) of the lid (10) so that the tip substantially reaches the inner wall of the bottom of the tubes;
delivering the sample into the tubes using the pipette; and
removing the tip (5) of the pipette from the tubes (2), the plugs (3) and the chimneys (11).

15. The method according to claim 13, according to which a film able to be perforated by a tip of a pipette (5) is interposed between the plugs (3) and the lid, before the assembly between the tray and the lid, so as to serve as a fill indicator for filling the tubes with the liquid.

16. The method according to claim 13, according to which a film able to be perforated by a tip of a pipette (5) is placed on the upper surface of the chimneys (11) of the lid (10).

17. The method according to claim 13, according to which the unitary assembly for holding the tubes between the lid (10) and the tray (7) is introduced into a centrifugation machine, in particular a vertical machine, to ensure an operation of centrifugation of the contents of the tubes.

18. The method according to claim 17, according to which, after carrying out the centrifugation operation:
the lid (10) is separated from the tray (7) and deposited on a laying plane;
the tray (7) is placed in a position of superposition above the lid (10) so as to engage the bottom of the tubes protruding from the lower face of the tray in the chimneys (11) of the lid so that they ensure the holding of the tubes;
the plugs (3) of the tubes are removed to be replaced by optical plugs to allow carrying out an operation of; amplification of the nucleic acids contained in the tubes;
the lid (10) is placed in a position of superposition above the tray (7) and removably assembled to the tray in order to form a unitary assembly for holding the tubes.

19. The method according to claim 17, comprising:
loading the unitary assembly for holding the tubes in an analysis machine;
removing the lid (10) relative to the tube support tray (7);
holding the tubes against the tray, by a bearing element of the analysis machine, during a tube heating operation; and
carrying out the operation of amplification of the contents of the tubes by the analysis machine.
